(19) United States
(12) Patent Application Publication
(10) Pub. No.: US 2025/0360781 A1
(43) Pub. Date: Nov. 27, 2025

(54) Battery Mount Reinforcements

(71) Applicant: Zephyros, Inc., Romeo, MI (US)

(72) Inventors: Nuria Ignes, Molsheim Cedex (FR); Gerald Bugli, Molsheim Cedex (FR); Frederic Degoutte, Molsheim Cedex (FR)

(21) Appl. No.: 18/874,259

(22) PCT Filed: Jun. 20, 2023
(86) PCT No.: PCT/US2023/025759

§ 371 Date: Dec. 12, 2024

Related U.S. Application Data
(60) Provisional application No. 63/353,757, filed on Jun. 20, 2022.

(51) Int. Cl. B60K 1/04; C08J 9/228; H01M 50/249; H01M 50/262

(52) U.S. Cl. CPC B60K 1/04; C08J 9/228; H01M 50/249; H01M 50/262; H01M 2220/20

(57) ABSTRACT

A vehicle frame and battery frame assembly comprising a vehicle frame portion, a battery frame portion connected to the vehicle frame portion via one or more battery mounts, and one or more reinforcement devices in direct contact with the one or more battery mounts, the reinforcement device comprising one or more of a foamed material, a foamable material, a polymeric support structure, or some combination thereof.

### CLAIM OF PRIORITY

This application claims the benefit of the filing date of U.S. Provisional Application Ser. No. 63/353,757, filed Jun. 20, 2022. The entirety of the contents of that application are incorporated by reference herein in their entirety and for all purposes.

### FIELD

The present teachings generally relate to devices and methods for reinforcing vehicle battery mount structures. The devices and methods described herein may be particularly advantageous in providing improved reinforcement for a vehicle frame as compared to standard battery mount structures without the reinforcement devices.

### BACKGROUND

The use of devices for improving the strength of vehicle structural frames is generally known. In electric vehicles, the traditional vehicle frame is connected to the battery frame. The battery frame is a very stiff sub-system. Unfortunately, the vehicle frame cannot properly benefit from this stiff component, as the vehicle frame and battery frame act as independent elements, despite their connection via the battery mounts.

Vehicle mount structures are also known. For example, mount structures are utilized for connecting the car body to the vehicle suspension. Reinforcing structures have been used to provide additional support to such mount structures for minimizing vibration of the vehicle body. However, traditional mount reinforcing structures do not provide a means for improving the overall stiffness of the vehicle body-in-white.

It would therefore be desirable for the vehicle frame and body-in-white to benefit from the stiffness of the battery frame.

### SUMMARY

The present teachings relate to a vehicle frame and battery frame assembly comprising a vehicle frame portion, a battery frame portion connected to the vehicle frame portion via one or more battery mounts, and one or more reinforcement devices in direct contact with the one or more battery mounts, the reinforcement device comprising one or more of a foamed material, a foamable material, a polymeric support structure, or some combination thereof.

The one or more reinforcement devices may comprise a foamed material that foams and/or cures at room temperature (20° C.-25° C.). The one or more reinforcement devices may comprise a polymeric carrier including one or more portions of foamable material. The foamed material or foamable material may adhere the one or more battery mounts to the vehicle frame portion. The one or more reinforcement devices may comprise a polymeric carrier including a plurality of surfaces that are substantially free of any foamed or foamable material.

A recessed cavity in the vehicle frame portion may receive the one or more reinforcement devices. The one or more reinforcement devices may include a central portion shaped for receiving a battery mount.

The central portion may be substantially round or curved in shape.

The one or more reinforcements may include a plurality of ribs that extend outward radially from the central portion.

The one or more reinforcement devices may include a foamed material that is pumped into a cavity surrounding the battery mount.

The foamed material may be adapted for curing at room temperature (20° C.-25° C.).

The one or more reinforcement devices may include a foamed material that comprises a phosphate ester material.

The one or more reinforcement devices may include a foamed material and may be free of any polymeric support structure.

The one or more reinforcement devices may include a foamable material that expands and/or cures upon exposure to heat.

The one or more reinforcement devices may include an injection molded polymeric support structure having a foamable material molded onto the support structure in a multi-shot molding process.

The one or more reinforcement devices may be located into a cavity formed in the vehicle frame structure and the one or more reinforcement devices are adhered to a portion of the cavity via the foamed or foamable material.

The vehicle frame structure and battery mounts may be metallic, and the one or more reinforcement devices may be non-metallic.

The one or more reinforcement devices may provide from about 5% to about 10% improved global static torsion stiffness of the vehicle frame when compared to an assembly without the one or more reinforcement devices.

The one or more reinforcement devices may include a support structure that substantially surrounds the one or more battery mounts.

The one or more reinforcement devices include a support structure overmolded with a foamable material.

The one or more reinforcement devices may include a polymeric support structure comprising polyamide, polyvinyl chloride polyetherimide, polycarbonate, poly(methyl methacrylate), acrylonitrile butadiene styrene, polyetherketoneketone, polyaryletherketone, polyether ether ketone, polyphenylene sulfide, polyethylene terephthalate, polypropylene, polyethylene, or any combination thereof.

One or more of the foamed material, the foamable material, or the polymeric support structure include one or more reinforcing materials selected from mineral reinforcement, glass reinforcement, carbon reinforcement, polymeric reinforcement, elastomeric reinforcement, core-shell polymer, or any combination thereof.

The foamed material, the foamable material or the support structure may include one or more ribs of a uniform pattern and orientation or of differing pattern and orientation.

The one or more reinforcements may include the foamed material substantially surround by the support structure.

The one or more reinforcement devices may include one or more openings for receiving a mechanical fastener, a foamed material, a foamable material or some combination thereof.

The one or more reinforcement devices may include a plurality of ribs that extend outward radially from a central portion of the one or more reinforcement devices. The one or more reinforcement devices may include a plurality of ribs that extend in a substantially parallel direction to one another.

The one or more reinforcements may be located in a cavity formed in the vehicle frame portion, the cavity formed by a base wall and a first and second side wall and the one or more reinforcements lie in direct contact with both first and second side walls.

The one or more reinforcements may be located in a cavity formed in the vehicle frame portion, the cavity formed by a base wall and a first and second side wall and the one or more reinforcements are located so that they fill a cross section of the cavity.

A vehicle battery may be located into contact with the battery frame portion.

### BRIEF DESCRIPTION OF THE DRAWINGS

FIG. 1 shows a profile view of a vehicle frame and battery assembly in accordance with the prior art.

FIG. 2 shows a profile view of an exemplary vehicle frame and battery assembly in accordance with the present teachings.

FIG. 3 shows an exemplary vehicle frame and the location of the battery mounts on the vehicle frame.

FIGS. 4A, 4B and 4C show cross-section views of exemplary battery mounts without reinforcements and with reinforcements.

FIG. 5 shows a perspective view of a vehicle frame and battery assembly in accordance with the prior art.

FIG. 6 shows a perspective view of an exemplary vehicle frame and battery assembly in accordance with the present teachings.

FIG. 7 shows a perspective view of an exemplary battery mount reinforcement in accordance with the present teachings.

FIG. 8 shows a cross-section view of an exemplary battery mount reinforcement in accordance with the present teachings.

FIG. 9 shows a perspective view of an exemplary vehicle frame and battery assembly in accordance with the present teachings.

FIGS. 10A and 10B show opposing perspective views of an exemplary battery mount reinforcement device.

### DESCRIPTION

The present teachings meet one or more of the above needs by the improved apparatus and method described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Electric vehicles use mount structures (fasteners) to connect that battery frame to the vehicle frame. Despite the significant stiffness of the battery frame, the vehicle body is not able to benefit from this stiffness. The current teachings are directed to reinforcing devices that overcome this challenge and allow the vehicle body to use the stiffness of the battery frame so that the global static torsion stiffness of the vehicle body-in-white. When connecting the battery frame to the vehicle frame, reinforcement devices located within and/or around the mount are found to add stiffness to the global vehicle. Essentially, the reinforcing devices act as a stiffness facilitator by creating a macrostructure including the battery frame, the vehicle body-in-white and the reinforcing device itself. The reinforcing devices described herein may provide significant benefits for hatchback and station wagon architectures, as often the most sensitive areas of the vehicle body to increase the global torsional stiffness of the body-in-white is the rear of the vehicle body. By including reinforcing devices about the battery mounts as described herein, significant improvements in global static torsion may be realized which is one of the principal performance indicators for global stiffness in electric vehicles.

Unlike traditional mount structures which are used to connect a strut with the body-in-white, the use of reinforcing devices in combination with mounts for a battery frame provide a unique means for allowing the body-in-white to benefit from the stiffness of the battery frame.

Battery-powered (e.g., electric or hybrid) vehicles may include a battery that functions to generate power and deliver the power to drive wheels. The battery may be located in any portion of the vehicle including but not limited to under a floor pan, on top of a floor pan, under a seat, in a luggage compartment, in an engine bay, or any combination thereof. For example, the battery may be substantially planar and extend, under the floor pan, fully from the left side of the vehicle to the right side of the vehicle and fully between the rearward wheel well and the forward wheel well. The battery is typically located onto a battery frame. The battery frame may be substantially planar.

The vehicle frame may function as the structural framework of the vehicle, to accept components of the vehicle (e.g., engine, drivetrain, doors, seats, and the like), to absorb forces from an impact event, to prevent intrusion of crash objects (e.g., vehicles, signposts, poles, concrete dividers, and the like), to protect passengers, to protect vehicle components (e.g., engine or batteries), or any combination thereof. The frame may include any conventional frame components including but not limited to: front aprons, quarter panels, A-pillars, B-pillars, C-pillars, sills, rockers, bumper beams, floor pans, cross-members, or any combination thereof. The frame may define a frame enclosure, a forward wheel well (i.e., in the forward end of the vehicle), a rearward wheel well (i.e., in the rearward end of the vehicle), or any combination thereof.

The battery frame may function to secure a battery in place, encapsulate a battery, provide a protective barrier for the battery or any combination thereof. The battery frame may be located within a space formed by the vehicle frame or proximate to the vehicle frame. The battery frame may be located within or proximate to a passenger compartment or may span more than one passenger compartment. For example, the battery frame may be located under a seat of a passenger compartment adjacent the rearward wheel well. As another example, the battery frame may span the left passenger compartment and the right passenger compartment of the vehicle. The battery frame may sit atop a floor frame or be fastened to the frame under a floor frame or perhaps be fastened to any other frame component. The battery frame may comprise a single component or multiple components. A single component battery frame may fasten to the frame of the vehicle to form an enclosure (e.g., a single component fastened to the underside of the floor frame whereby the battery is fully encapsulated between the floor frame and the single component). The constituent parts of multiple component battery frames may form a complementary fit and encapsulate the battery. The battery frame may also house components typically found in electric drive systems including but not limited to heaters, controllers, insulation, a junction box, or any combination thereof.

The battery frame may be connected to the vehicle frame via one or more mount structures. The one or more mount structures may be formed as mechanical fasteners. The one or more mount structures may include one or any combination of protrusions, extensions, tabs, springs, threaded fasteners, hook and latch, snap fittings, tree clips, or friction fit fasteners. The one or more mount structures may be contacted with an adhesive. One or both of the vehicle frame and battery frame may include an opening for receiving a mount structure. The one or more mount structures may include a bolt. The one or more mount structures may include a portion attached to the vehicle frame or battery frame via a welding process.

The one or more mount structures may connect the battery frame to the vehicle frame. The vehicle frame may include one or more rockers, bumper beams, and pillars. The rockers may include two rockers, one employed on a sill of the left side, and one employed on a sill of the right side. The rockers may comprise polymer, metal, or both. The mating of a rocker with a sill may result in the formation of a cavity, which may be suitable to house a carrier. The bumper beams may function to reinforce the forward end of the vehicle, the rearward end of the vehicle, or both. The bumper beams may be configured to resist intrusion of a crash object into the engine compartment of the vehicle, the luggage compartment of the vehicle, or both. The bumper beams may be located behind the rear bumper (i.e., body panel) and front bumper (i.e., body panel). The bumper beams may comprise polymer, metal, or both. The pillars may be formed to support and protect the passenger compartment and other areas and structures in between the floor and roof of the vehicle. The pillars may comprise polymer, metal, or both.

The one or more mount structures may be fitted with one or more reinforcements (e.g., reinforcement devices). The reinforcements may include a foamed material, a foamable material, a carrier, or some combination thereof. The reinforcements may substantially surround the one or more mount structures. The reinforcements may improve the strength of the connection between the vehicle frame and battery frame so that the vehicle frame has improved global static torsion stiffness as compared to mount structures without reinforcements. The reinforcements may be located in direct contact with the one or more mount structures, the vehicle frame, the battery frame, or any combination thereof. The reinforcements may adhere via an adhesive to one or more of the mount structures, vehicle frame, battery frame, or any combination thereof. The reinforcements may be mechanically connected to or engaged in a friction fit connection with one or more of the mount structures, vehicle frame, battery frame, or any combination thereof.

The one or more reinforcements may include a foamed material. It is possible that this foamed material may be pumped into a cavity surrounding the one or mount structures and will foam prior to or simultaneously during pumping. The foamed material may foam at room temperature (e.g., 20° C.-25° C.) or may require heat for foaming. The foamed material may be the only material forming the reinforcement. The reinforcement may be substantially free of any material or device other than the foamed material. The reinforcements may be substantially free of any carrier beyond the mount structures, vehicle frame and battery frame. Alternatively, the foamed material may be located on a carrier. The foamed material may act as an adhesive and adhere to one or more of the mount structures, vehicle frame, or battery frame.

The one or more reinforcements may include a foamable material. Typically, such foamable material foams upon exposure to a stimulus. Such stimuli may include but are not limited to heat, UV light, moisture, pressure, or the like. The foamable material may be located on a carrier that is received by a cavity adjacent the one or more mount structures. Alternatively, the foamable material may be applied directly to a wall of a cavity adjacent the one or more mount structures and be substantially free of any carrier. The foamable material may act as an adhesive and adhere to one or more of the carrier, the mount structures, the vehicle frame or the battery frame. The one or more reinforcements may comprise a polymeric carrier including one or more portions of foamable material. The foamed material or foamable material may adhere the one or more battery mounts to the vehicle frame portion.

Any foamable material located near or adjacent any battery or battery frame may be present in an amount sufficient to help 1) to manage thermal dissipation from any potential runaway heat, and also 2) to insulate against any runaway electrical discharge, and effectively insulate electrically and/or function for grounding.

If present, the carrier may have a substantially uniform or non-uniform cross-sectional geometry along a longitudinal axis. The carrier may have a substantially uniform or non-uniform cross-sectional geometry along any transverse axis (i.e., any axis perpendicularly intersecting the longitudinal axis and not limited to any radial orientation). For example, the carrier may have a rectangular cross-section along a transverse axis (i.e., uniform cross-sectional geometry) or may be an L-shaped cross-section along a transverse axis (i.e., non-uniform cross-sectional geometry). The geometry along the longitudinal axis and the transverse cross-section may substantially correspond with the geometry of the frame member that receives the carrier. The geometry of the carrier may be radial in nature such that a circular central portion of the carrier substantially surrounds a mount structure. The carrier may include a flat outer surface, configured to engage and contact a cavity wall (either directly or with a layer of foamable material located therebetween). The carrier may include a top edge (i.e., configured to face the roof of the vehicle) and a bottom edge (i.e., configured to face toward the ground). The carrier may comprise one or more base materials, one or more reinforcement materials, one or more additives, or any combination thereof. The carrier may include a periphery, ribs, foamable material, or any combination thereof.

The reinforcements may include one or more ribs. The ribs may inhibit bending, torsion, or both. The ribs may project from a central portion of the reinforcements. The ribs may lie parallel to one or more additional ribs or may lie perpendicular or skew to one or more additional ribs. One or more ribs may intersect with another rib. The ribs may have a thickness of about 0.5 mm to about 2 cm.

The foamed material and/or the foamable material may function to provide baffling, sealing, structural reinforcement, or any combination thereof. The foamed material and/or the foamable material may help to manage thermal dissipation from any potential runaway heat related to battery use. The foamed material and/or the foamable material may insulate against any runaway electrical discharge, and effectively insulate electrically and/or function for grounding. The foamed material and/or the foamable material may be activated to cure, expand (e.g., foam), soften, flow or any combination thereof. The foamed material and/or the foamable material may cover a substantial portion (e.g., at least 40%, 60%, 80% or more) of the surface area of the carrier and/or a cavity which receives the reinforcement. A variety of foamed and/or foamable materials may be used for forming the reinforcements. The foamed material and/or the foamable material may be generally dry to the touch and substantially non-tacky or may be tacky and, in either situation, may be shaped in any form of desired pattern, placement, or thickness, but is preferably of substantially uniform thickness. Exemplary heat-activated foamable materials include L-5520, L-5505, L-5540, L-5905, L-5920, L-5904, L-5235, L-5236, and L-5244 foams, commercially available through L&L Products, Inc. Exemplary foamed materials are disclosed in PCT Publication Nos. WO 2020/101732, WO 2020/205355, WO 2020/206346, and WO 2020/198139, which are all incorporated by reference herein in their entirety for all purposes. Such materials involve the use of phosphoric acid and phosphate esters for cure-in-place compositions. These compositions are typically employed for a wide range of room-temperature activated systems, such as rigid structural foams, cavity filling, gaskets, and sealants. The benefits of such compositions may include the ability to adhere to a variety of substrates, the inclusion of low volatility organic compounds (VOC's), not being sensitive to the dispensing temperature, not being sensitive to the exact mixing ratio of a two-part system, the ability to tune physical and mechanical properties, or any combination thereof.

In some applications, two or more carriers may be employed for a single mount structure. Alternatively, a single carrier may be utilized. Where two or more carriers are employed, the carriers may or may not be fastened together. The carriers may be fastened by adhesive, welding, or fasteners.

The carrier, if present, may comprise a composite of one or more base materials, one or more reinforcing materials, or both. The composite may be layered or homogenous. Layered composites may comprise two or more discrete layers and each of the discrete layers may be rigid, ductile, or both. The layers may comprise adhesives, sealants, tapes, or other materials for connecting the composite layers. Such adhering and/or sealing materials may also be arranged so that a more ductile material is arranged adjacent to a more rigid and/or brittle (e.g., less ductile) material. For example, via a co-extrusion process, a less rigid polymer (e.g., polyethylene) may be layered with a more rigid polymer (e.g., polyamide). And a less rigid adhesive may be layered with a more rigid one. Uniformly dispersed composites may comprise two or more constituents that are present substantially uniformly throughout the ribs, periphery, or both. For example, via a pultrusion process glass fibers may be coated with a polymer (e.g., polyamide) to result in a uniform distribution of glass fibers within the polymer.

The carrier may comprise one or more base materials. The carrier may comprise polymer, metal, or both. The polymer may include polyamide (“PA”), polyvinyl chloride (“PVC”) polyetherimide (“PEI”), polycarbonate (“PC”), poly (methyl methacrylate) (“PMMA”), acrylonitrile butadiene styrene (“ABS”), polyetherketoneketone (“PEKK”), polyaryletherketone (“PAEK”), polyether ether ketone (“PEEK”), polyphenylene sulfide (“PPS”), polyethylene terephthalate (“PET”), polypropylene (“PP”), polyethylene (“PE”), or any combination thereof. The metal may include aluminum, steel, brass, magnesium, zinc, titanium, metal alloy, or any combination thereof. The one or more base materials may be present in an amount of about 1% to about 70% by weight of the carrier. The carrier may comprise a single base material (i.e., a homogenous carrier) or more than one base material (i.e., a composite carrier).

The one or more reinforcing materials may function to enhance the properties of the carrier such as improve tensile strength, improve flexural strength, distribute energy within the reinforcement, or any combination thereof. The reinforcing materials may include mineral reinforcement, glass reinforcement, carbon reinforcement, polymeric reinforcement, elastomeric reinforcement, core-shell polymer, or any combination thereof. The one or more reinforcing materials may be present in an amount of about 0% to about 70% by weight of the carrier.

The glass reinforcement may be chosen from glass fibers, glass beads, or glass bubbles (“microspheres”). The glass reinforcement may include alumino-borosilicate glass (“E-glass”), alkali-lime glass (“A-glass” or “C-glass”), electrical/chemical resistance glass (“E-CR-glass”), borosilicate glass (“D-glass”), alumino-silicate glass (“R-glass” or “S-glass”), or any combination thereof. The glass reinforcement may be chopped fiber. The glass reinforcement may be a fiber chopped to a length of about 0.1 cm or more, about 0.3 cm or more, or even about 0.6 cm or more. The glass reinforcement may be a chopped length of about 2.0 cm or less, about 1.5 cm or less, or even about 1.0 cm or less.

The carbon reinforcement may include carbon fibers or woven fabrics. The carbon reinforcement may be 1K, 2K, 3K, 4K, 5K, or even 6K (i.e., 1K denotes 1000 fiber filaments in one bundle).

The carrier may be produced by methods including injection molding, extrusion, co-extrusion, pultrusion, or any combination thereof.

The carrier may be produced via injection molding. Injection molding may be suitable for the production of homogenous carriers or composite carriers. Homogenous carriers may be obtained by the injection molding of one base material. Composite carriers may be obtained by the injection molding of one or more base materials with one or more reinforcing materials, or two or more base materials. The injected material may be a uniform mixture of one or more base materials with one or more reinforcing materials. For example, polyamide may be mixed with glass fiber reinforcement prior to injection into a mold. As another example, a single cylinder may deliver a first base material to the mold cavity and thereafter may deliver a second base material into the mold cavity resulting in the first base material being pushed to the periphery of the mold cavity by the second base material and as a result the second base material may be situated in a proximal area of the mold cavity (i.e., layered distribution). As another example, a dual cylinder system may involve a first cylinder delivering a first base material to one distal end of a mold cavity while a second cylinder delivers a second base material to the other distal end of the mold cavity, resulting in a substantially bisectional distribution of the first base material and the second base material (i.e., sectional distribution). Any combination of the above-described techniques may be employed in order to obtain a carrier having any combination of one or more base materials, one or more reinforcing materials, or both in a variety of layered distributions, sectional distributions, or both.

The carrier may be produced via extrusion. Extrusion may be suitable for the production of homogenous or composite articles. Extrusion may provide for a continuous piece that exits a die and may thereafter be cut to length to form an individual carrier. Homogenous articles may be obtained by the extrusion of one base material. For example, the carrier may be obtained by extruding aluminum. Composite articles may be obtained by the extrusion of one or more base materials with one or more reinforcing materials. The extruded material may be a uniform mixture of one or more base materials with one or more reinforcing materials. For example, polyamide may be mixed with glass fiber reinforcement prior to extrusion. The extruded material may be a combination of two or more base materials. For example, a first material and a second material may be fed into a flow channel before exiting through the die (i.e., co-extrusion), which may result in a carrier having a sectional distribution of the first material and the second material. Co-extrusion may be utilized to obtain one or more, two or more, eight or less, or even seven or less layers of base material. Any combination of the above-described techniques may be employed in order to obtain a carrier having any combination of one or more base materials, one or more reinforcing materials, or both in a variety of layered distributions, sectional distributions, or both.

The carrier may be produced via pultrusion. Pultrusion may be suitable for the production of composite articles. Pultrusion may provide for a continuous piece that exits a die and may thereafter be cut to length to form an individual carrier. Pultrusion may be utilized in conjunction with roving, fabrics (e.g., unidirectional, woven, multiaxial, or random orientation (chopped strand mat)), or films. Pultrusion may involve feeding one or more base materials, one or more reinforcement materials, or both through an impregnation bath of one or more base materials before forming the materials via a die. For example, glass fiber roving may be fed through an impregnation bath of polyamide and thereafter guided through a die having cantilevered mandrels, which form voids between the ribs. As another example, steel wire may be fed through an impregnation bath of polyamide and thereafter guided through a die having cantilevered mandrels, which form the voids between the ribs. Any combination of the above-described techniques may be employed in order to obtain a carrier having any combination of one or more base materials, one or more reinforcing materials, or both in a variety of layered distributions, sectional distributions, or both.

The addition of the reinforcements as described herein allows the vehicle body-in-white to benefit from the stiffness of the battery tray. More specifically, the use of the reinforcements as described herein improve the overall body torsional stiffness of the vehicle. Body torsional stiffness is the resistance to twist that the car body has when a torsional load or a twisting load is applied to the body in white. For measuring global static torsion stiffness, a static moment is applied to the body-in-white at the front shock towers, whereas the rear shock towers are constrained. The torsion angle (θ) is typically defined as the resulting deformation angle between the front and rear shock towers. The corresponding torsion stiffness can be calculated as the ratio of applied static moment to the torsion angle. In adding the reinforcements described herein to the assembly of the battery frame, vehicle frame and battery mounts, an improvement of up from 1% to about 10% for the global static torsion stiffness is realized. This result may be further improved when applying similar reinforcement devices for other areas of the vehicle where mounts are utilized (such as the D-Pillar).

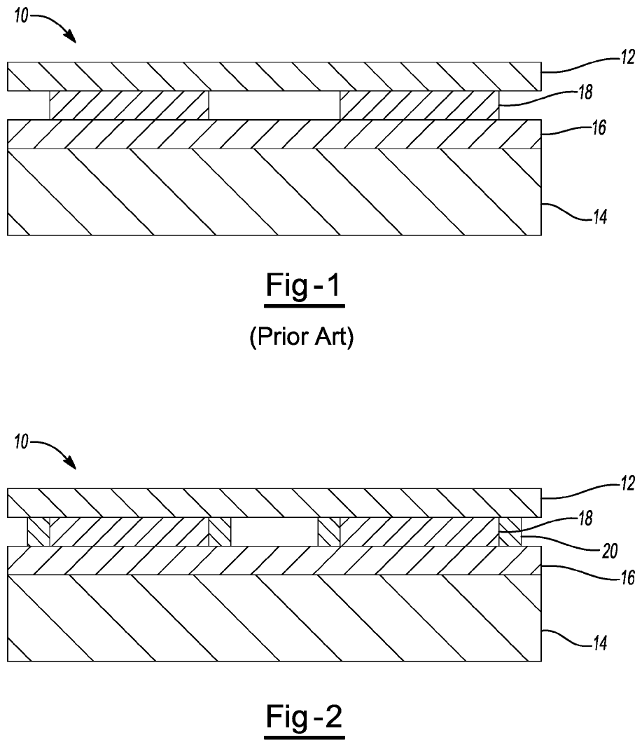

FIG. 1 illustrates a profile view of an assembly 10 in accordance with the prior art. The assembly 10 includes the vehicle frame/body in white 12, battery 14, battery frame, 16 and mount structures 18. Despite the significant stiffness of the battery and battery frame assembly 14, 16, the benefit of the stiffness is not realized by the vehicle frame 12.

FIG. 2 illustrates a profile view of an exemplary assembly 10 in accordance with the teachings herein. The assembly 10 includes the vehicle frame 12, battery 14, battery frame, 16 and mount structures 18. In addition, the mount structures 18 are contacted by reinforcements 20.

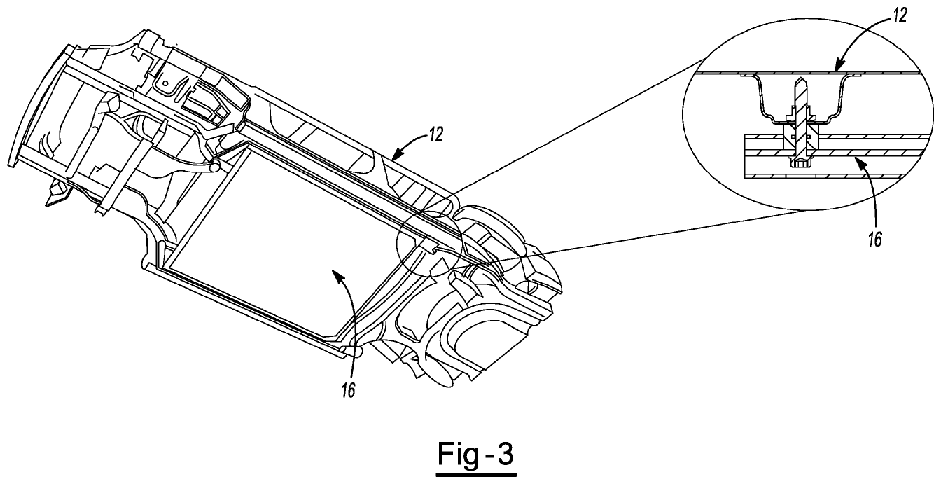

FIG. 3 illustrates an exemplary vehicle frame 12 and the location of the battery mounts 18 between the vehicle frame 12 and battery tray 16.

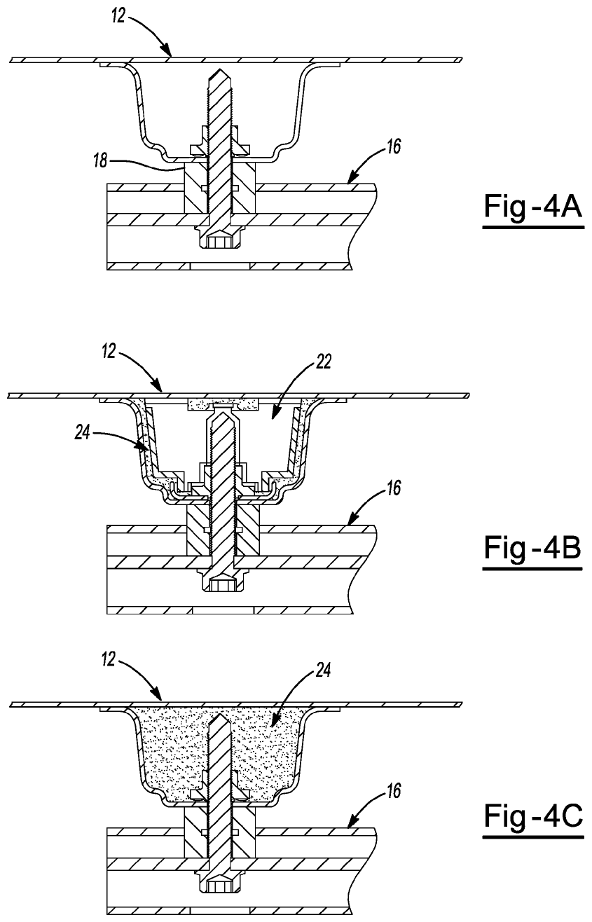

FIG. 4A illustrates a cross-section view of an exemplary battery mount 18 without reinforcements where the battery mount 18 connects the battery frame 16 to the vehicle frame 12. FIG. 4B illustrates a cross-section view of an exemplary battery mount 18 with reinforcements including a carrier material 22 and a foamable material 24 (shown after the foamable material has foamed). FIG. 4C illustrates a cross-section view of an exemplary battery mount 18 with reinforcements, the reinforcement being free of a carrier material and including a foamed material 24 that has been pumped into the vehicle mount cavity.

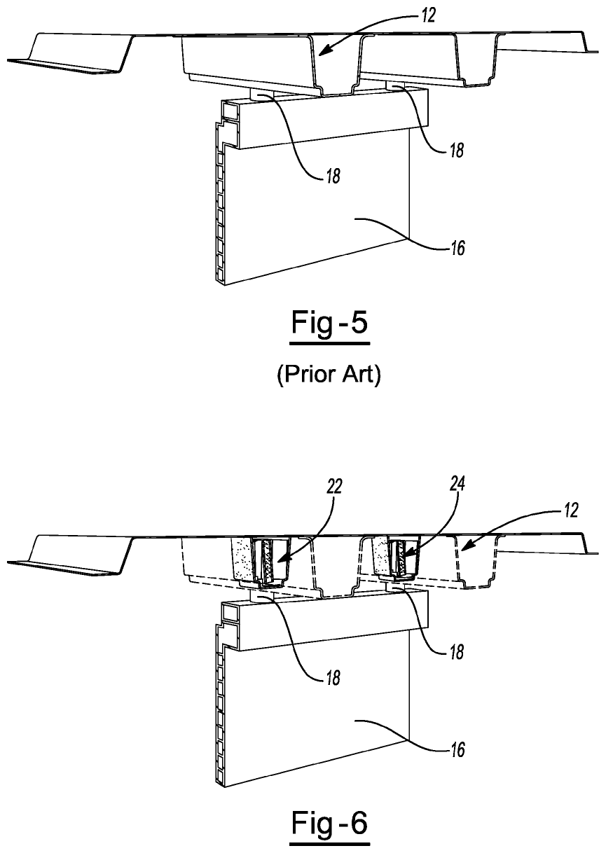

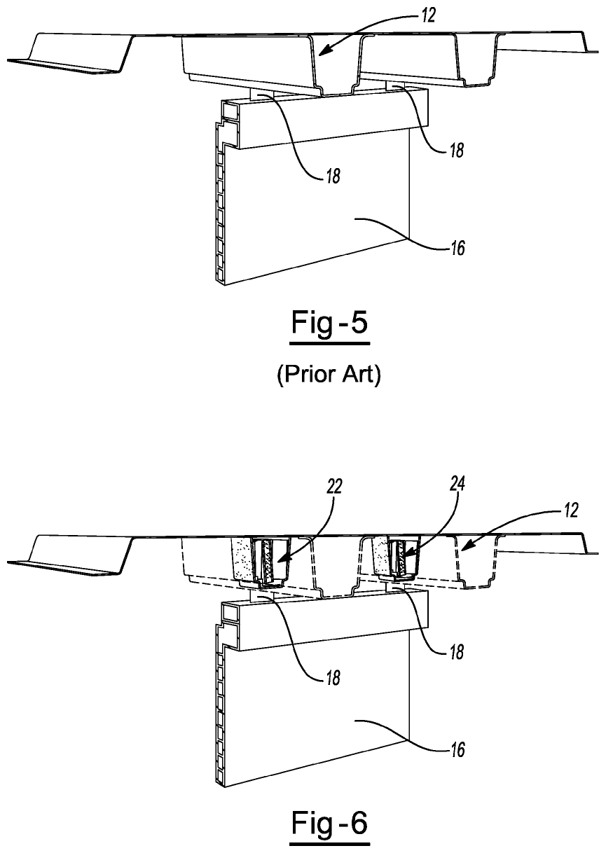

FIG. 5 shows a perspective view of the prior art assembly shown at FIG. 1. The assembly includes the vehicle frame 12, the battery frame 16, and the mount structures 18.

FIG. 6 shows the assembly of FIG. 5 including the reinforcements 22, 24 described herein. The reinforcements are shown having a carrier 22 and a foamable material 24 (shown prior to foaming).

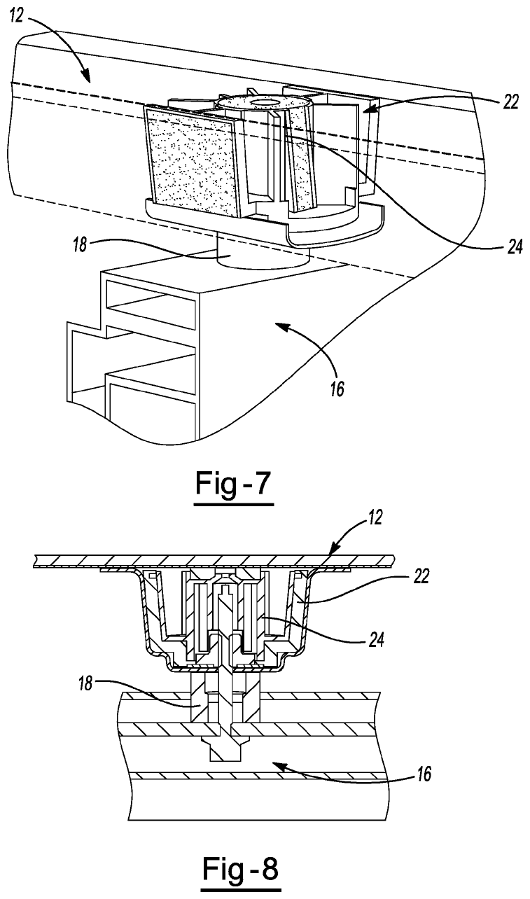

As shown in FIG. 7, the reinforcement 22, 24 may be located into a cavity formed in a vehicle frame 12. The foamable material 24 (shown prior to foaming) may be formed on a surface of the carrier 22 so that the reinforcement lies in direct contact with and adheres to a wall of the vehicle frame 12. The carrier 22 is shown as substantially surrounding a portion of the mount structure 18.

FIG. 8 shows a cross-section view of the assembly shown at FIG. 7. The carrier 22 of the reinforcement is located so that it substantially surrounds a portion of the mount structure 18, while the foamable material 24 (shown prior to foaming) is located along a wall of the vehicle frame 12. The carrier 22 and foamable material are substantially free of any direct contact with the battery frame 16.

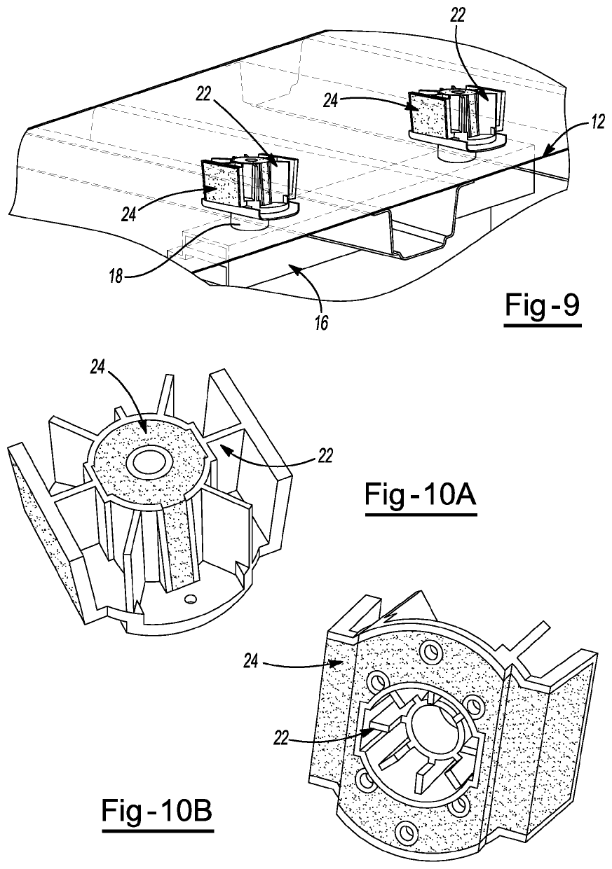

FIG. 9 shows multiple reinforcements 22, 24 located into two separate cavities formed in a vehicle frame 12. The foamable material 24 (shown prior to foaming) may be formed on a surface of the carrier 22 so that the reinforcement lies in direct contact with and adheres to a wall of the vehicle frame 12. The carrier 22 is shown as substantially surrounding a portion of the mount structure 18 and free of direct contact with the battery frame 16.

FIGS. 10A and 10B illustrate the reinforcement 22, 24 as viewed from above and below including a central portion 28 having an opening for receiving a portion of the mount structure (not shown), a plurality of ribs 26 extending radially from the central portion 28, and a plurality of openings 30 formed in the bottom portion of the carrier 22.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

1. A vehicle frame and battery frame assembly comprising:
i) a vehicle frame portion;
ii) a battery frame portion connected to the vehicle frame portion via one or more battery mounts;
iii) one or more reinforcement devices in direct contact with the one or more battery mounts, the reinforcement device comprising one or more of a foamed material, a foamable material, a polymeric support structure, or some combination thereof.

2. The assembly of claim 1, wherein the one or more reinforcement devices comprise a foamed material that foams and/or cures at room temperature (20° C.-25° C.).

3. The assembly of claim 1, wherein the one or more reinforcement devices comprise a polymeric carrier including one or more portions of foamable material.

4. The assembly of claim 1, wherein the foamed material or foamable material adheres the one or more battery mounts to the vehicle frame portion.

5. The assembly of claim 1, wherein the one or more reinforcement devices comprise a polymeric carrier including a plurality of surfaces that are substantially free of any foamed or foamable material.

6. The assembly of claim 3, wherein a recessed cavity in the vehicle frame portion receives the one or more reinforcement devices.

7. The assembly of claim 3, wherein the one or more reinforcement devices include a central portion shaped for receiving a battery mount.

8. The assembly of claim 7, wherein the central portion is substantially round in shape.

9. The assembly of claim 7, wherein the one or more reinforcements include a plurality of ribs that extend outward radially from the central portion.

10. The assembly of claim 1, wherein the one or more reinforcement devices include a foamed material that is pumped into a cavity surrounding the battery mount.

11. The assembly of claim 10, wherein the foamed material is adapted for curing at room temperature (20° C.-25° C.).

12. The assembly of claim 1, wherein the one or more reinforcement devices include a foamed material that comprises a phosphate ester material.

13. The assembly of claim 2, wherein the one or more reinforcement devices include a foamed material and is free of any polymeric support structure.

14. The assembly of claim 1, wherein the one or more reinforcement devices include a foamable material that expands and/or cures upon exposure to heat.

15. The assembly of claim 7, wherein the one or more reinforcement devices include an injection molded polymeric support structure having a foamable material molded onto the support structure in a multi-shot molding process.

16. The assembly of claim 1, wherein the one or more reinforcement devices are located into a cavity formed in the vehicle frame structure and the one or more reinforcement devices are adhered to a portion of the cavity via the foamed or foamable material.

17. The assembly of claim 2, wherein the vehicle frame structure and battery mounts are metallic, and the one or more reinforcement devices are non-metallic.

18. The assembly of claim 16, wherein the one or more reinforcement devices provide from about 5% to about 10% improved global static torsion stiffness of the vehicle frame when compared to an assembly without the one or more reinforcement devices.

19. The assembly of claim 1, wherein the one or more reinforcement devices include a support structure that substantially surrounds the one or more battery mounts.

20. The assembly of claim 1, wherein one or more reinforcement devices include a support structure overmolded with a foamable material.

21-30. (canceled)
